(19) United States
(12) Patent Application Publication
(10) Pub. No.: US 2020/0027082 A1
(43) Pub. Date: Jan. 23, 2020

(54) VIRTUAL CURRENCY PAYMENT AGENT DEVICE, VIRTUAL CURRENCY PAYMENT AGENT METHOD, AND PROGRAM RECORDING MEDIUM

(71) Applicant: NEC Corporation, Minato-ku, Tokyo (JP)

(72) Inventor: Sanami NAKAGAWA, Tokyo (JP)

(73) Assignee: NEC Corporation, Minato-ku, Tokyo (JP)

(21) Appl. No.: 16/491,218

(22) PCT Filed: Mar. 29, 2017
(86) PCT No.: PCT/JP2017/012961

§ 371 Date: Sep. 5, 2019

(51) Int. Cl. G06Q 20/38; G06Q 20/06

(52) U.S. Cl. CPC G06Q 20/389; G06Q 20/0658

(57) ABSTRACT

The present invention enables a virtual currency payment to be processed by an agent in a decentralized virtual currency system. A payment agent device 10 comprises: a first generation unit 110 which, in response to a request from a payer, generates a first transaction that includes first destination information indicating at least an agent and a payee as destinations, and that also includes first amount information and approval information about the agent; and a second generation unit 120 which generates a second transaction on the basis of approval information about the payee transmitted from the payee, and using the first transaction as an outstanding amount, wherein the second transaction includes second destination information indicating the payee as a destination, and also includes second amount information, the approval information about the agent, and the approval information about the payee.

### TECHNICAL FIELD

The present invention relates to virtual currency payment agent devices and the like.

### BACKGROUND ART

Bitcoin (refer to NPL1) is a decentralized virtual currency that allows data of virtual currency to be shared in a distributed manner. Further, there is a blockchain technology as a technology that a large number of users broadcast data with each other so as to manage virtual currency. The virtual currency utilizing the blockchain technology keeps track of the transfer of value from a payer to a payee. Techniques related to virtual currency are disclosed, for example, in PTLs 1 and 2.

In general, the use of such virtual currency requires a user account (hereinafter, may also simply be referred to as an “account”). In order to acquire an account and manage virtual currency, the user needs to use an electronic device such as a personal computer (PC) and a smartphone. In addition, the technique relevant to payment agency in the electronic payment system (not virtual currency) is disclosed in PTL3 for example.

### CITATION LIST

### Patent Literature

[PTL 1] Japanese Unexamined Patent Application Publication No. 2016-170530 A

[PTL 2] Japanese Unexamined Patent Application Publication (Translation of PCT Application) No. 2013-531855 A

[PTL 3] Japanese Unexamined Patent Application Publication No. 2006-260277 A

### Non Patent Literature

[NPL 1]Satoshi Nakamoto, “Bitcoin: A Peer-to-Peer Electronic Cash System”, [online], [searched on Nov. 7, 2016], internet <URL: https://bitcoin.org/bitcoin.pdf>

### SUMMARY OF INVENTION

### Technical Problem

Also, in a decentralized virtual currency, a demand for the payment agency by an agent may be expected. For example, in the case of a limited number of uses, such as a one-time use, there is a need to make a virtual currency available without having to acquire an account. For example, for a person who is unfamiliar with the handling of electronic devices, complicated procedures such as acquiring an account may hinder the use of virtual currency. In addition, acquiring an account also causes the trouble of managing virtual currency thereafter.

Unfortunately, existing virtual currency systems such as those disclosed in PLs 1 and 2, and NPL1 do not enable the payment agency in a decentralized virtual currency system. In addition, the payment agency in an electronic payment system different from a virtual currency as disclosed in PL3 cannot be applied as it is to a decentralized virtual currency system.

An exemplary object of the present invention is to provide a technique enabling the payment agency of virtual currency in a decentralized virtual currency system.

### Solution to Problem

A payment agent device for a virtual currency according to an example aspect of the invention includes a first generation means for generating, in response to a request from a payer, a first transaction that includes first destination information indicating at least an agent and a payee as destinations, first amount information, and approval information of the agent and a second generation means for generating, based on approval information of the payee transmitted therefrom and using the first transaction as a balance, a second transaction that includes second destination information indicating the payee as a destination, second amount information, the approval information of the agent, and the approval information of the payee.

A payment agent method for a virtual currency according to an example aspect of the invention includes the steps of generating, in response to a request from a payer, a first transaction that includes first destination information indicating at least an agent and a payee as destinations, first amount information, and approval information of the agent and generating, based on approval information of the payee transmitted therefrom and using the first transaction as a balance, a second transaction that includes second destination information indicating the payee as a destination, second amount information, the approval information of the agent, and the approval information of the payee.

A computer-readable program recording medium according to an example aspect of the invention for causing a computer to execute the steps of generating, in response to a request from a payer, a first transaction that includes first destination information indicating at least an agent and a payee as destinations, first amount information, and approval information of the agent and generating, based on approval information of the payee transmitted therefrom and using the first transaction as a balance, a second transaction that includes second destination information indicating the payee as a destination, second amount information, the approval information of the agent, and the approval information of the payee.

### Advantageous Effects of Invention

In accordance with the present invention, the payment agency of virtual currency in a decentralized virtual currency system is enabled.

### BRIEF DESCRIPTION OF DRAWINGS

FIG. 1 is a block diagram illustrating an exemplary constitution of a payment agent device.

FIG. 2 is a sequence chart illustrating an exemplary procedure for the payment agency.

FIG. 3 is a block diagram illustrating another exemplary constitution of the payment agent device.

FIG. 4 is a flow chart illustrating an exemplary operation of the payment agent device.

FIG. 5 is a block diagram illustrating an exemplary constitution of a payment agent system.

FIG. 6 is a block diagram illustrating a still another exemplary constitution of the payment agent device.

FIG. 7 is a sequence chart illustrating an exemplary operation at the time of trading of a virtual currency.

FIG. 8 is a sequence chart illustrating another exemplary operation at the time of trading of a virtual currency.

FIG. 9 is a block diagram illustrating an exemplary hardware configuration of computer equipment.

### EXAMPLE EMBODIMENT

### First Example Embodiment

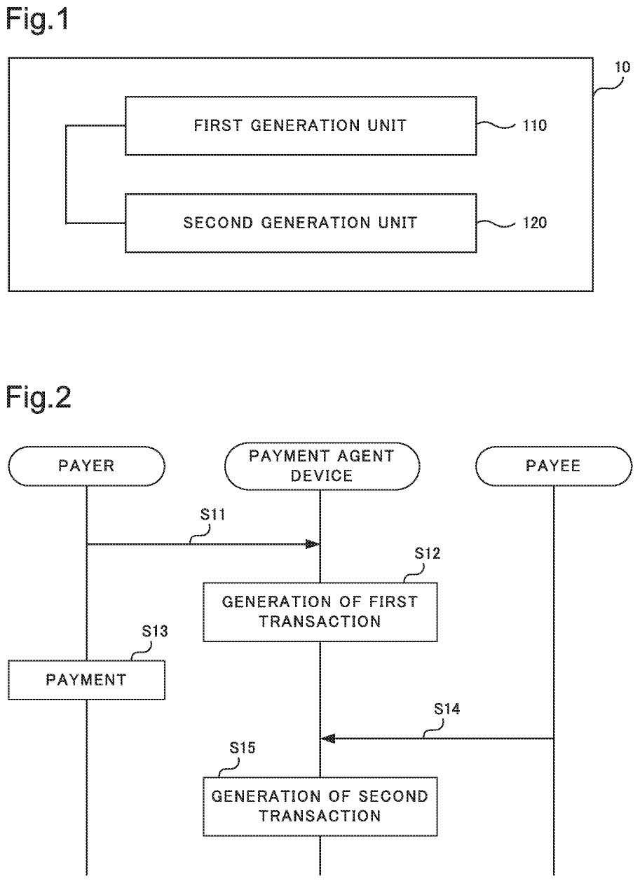

FIG. 1 is a block diagram illustrating a constitution of a payment agent device 10 according to one example embodiment. The payment agent device 10 is computer equipment applied to a decentralized virtual currency system. The payment agent device 10 at least includes a first generation unit 110 and a second generation unit 120. The payment agent device 10 may include any other components as needed.

As described herein, the decentralized virtual currency system refers to a virtual currency system that requires no specific organization (central organization). For example, a virtual currency system called Bitcoin is one example of the decentralized virtual currency system mentioned here. However, the payment agent device 10 is applicable not only to bitcoin but also to the payment agency of virtual currency in general using blockchain technology. The term “virtual currency system” described below means a decentralized virtual currency system using blockchain technology, unless otherwise specified.

The payment agent device 10 allows trading of virtual currency between a user who does not have an account of the virtual currency system (hereinafter, may also be referred to as a “payer”) and another user who has an account of the virtual currency system (hereinafter, may also be referred to as a “payee”). The present example embodiment enables such trading via an agent who operates the payment agent device 10. The payer may be paraphrased as a payment source. Also, the payee may be paraphrased as a receiver. Furthermore, the payer, payee, and agent are not limited to natural persons, but may be legal persons.

The first generation unit 110 generates a first transaction. As described herein, a transaction refers to data representing trading of a virtual currency, i.e., movement of monetary value. More specifically, the transaction at least includes destination information, amount information, and approval information. The transaction may include other information.

The destination information indicates the destination of the virtual currency. The destination information is configured to include a plurality of users as destinations. The identification of the user is performed, for example, by an account. An account is data that is assigned to uniquely identify a user, such as a so-called user identifier (user ID). Accounts are assigned to users upon use of the virtual currency system (e.g., upon registration). The user who has become the transaction destination needs approval information of the destination user in order to use the virtual currency corresponding to the transaction.

The amount information is information indicating the amount of monetary value. The amount information indicates, for example, the amount in a predetermined currency unit available in the virtual currency system. The virtual currency may be expressed in units unique to the virtual currency system, but may also be expressed by converting it to a nationally guaranteed currency (legal currency) such as the Japanese yen or the US dollar.

The approval information is information for guaranteeing the legitimacy of the transaction. The approval information is information associated to the account. The approval information is, for example, electronic signature data assigned to each user of the virtual currency system. Note that the electronic signature mentioned here is not necessarily limited to a specific system.

The first generation unit 110 generates a first transaction in response to a request from the payer. The first transaction includes first destination information indicating at least the agent and the payee as destinations, first amount information indicating a predetermined amount of money, and approval information of the agent. The predetermined amount of money mentioned here includes at least the amount to be payed from the payer to the payee, and may include necessary expenses (transaction recording and commission for the payment agency etc.) as necessary. Also, the first destination information here includes accounts of two users, but may include three or more accounts. For example, the first destination information may include accounts of a plurality of agents.

The first transaction is a transaction that functions as a so-called deposit. The fact that the first destination information includes a plurality of users as destinations means that the virtual currency cannot be used unless there is a plurality of approval information corresponding to the plurality of users. In other words, the first transaction is restricted for sole use of the agent or payee. The first transaction is generated, for example, using an unused virtual currency of the agent.

The second generation unit 120 generates a second transaction. The second generation unit 120 generates the second transaction using the first transaction generated by the first generation unit 110 and recorded in the blockchain as a balance.

The second transaction includes second destination information indicating a payee as a destination, second amount information indicating a predetermined amount, approval information of the agent, and approval information of the payee. The second amount information indicates an amount determined based on the first amount information. The amount indicated by the second amount information is equal to or less than the amount indicated by the first amount information. For example, the amount indicated by the second amount information may be the amount indicated by the first amount information minus some or all of the expenses.

The first transaction and the second transaction differ in the following points. First, while the first transaction includes the agent as the destination, the second transaction does not include the agent as the destination. Second, while the first transaction does not include the approval information of the payee, the second transaction includes the approval information of the payee.

The information not included in the first transaction but included in the second transaction is the approval information of the payee. The second generation unit 120 can generate the second transaction based on the approval information transmitted from the payee. The payee transmits his/her approval information to the payment agent device 10 after the payment from the payer to the agent. The second transaction generated by the second generation unit 120 is registered in the blockchain in a similar manner to the case of the first transaction.

The constitution of the payment agent device 10 is as described above. With such a constitution, the payment agent device 10 allows an agent to perform the payment agency of a virtual currency by operating as follows.

FIG. 2 is a sequence chart illustrating a procedure for the payment agency using the payment agent device 10. In step S11, the payer provides necessary information to the payment agent device 10. As described herein, the necessary information for the payment agency at least includes information for identifying a payee and information indicating an amount to be paid to the payee. The information for identifying the payee may be the account of the payee, but may be other information (such as name or title of the payee) associated with the account of the payee.

The manner for providing these pieces of information by the payer is not limited to a specific method. For example, the payer may transmit the necessary information to the payment agent device 10 using an electronic device such as a smartphone. Alternatively, the payer may visit a store operated by the agent and transmit the necessary information in writing or verbally, or may mail a document containing the necessary information to the agent.

For convenience of explanation, in the following, the act of providing information by the payer in step S11 is also referred to as a “request”. It can also be said that the request mentioned here is an indication of the intention for payment from the payer to the payee via the payment agent device 10.

The payment agent device 10 executes step S12 in response to the provision of such information, i.e., a request. In step S12, the first generation unit 110 generates a first transaction based on the information provided by the payer. As described above, the first transaction includes first destination information indicating the agent and the payee as destinations, first amount information, and approval information of the agent. The account of the payee and the first amount information are identified based on the information provided by the payer. In contrast, the account of the agent and approval information of the agent are recorded in advance in the payment agent device 10, or alternatively, can be acquired from a predetermined storage device.

The first transaction generated in step S12 is registered in the blockchain. For example, the first transaction is registered in the blockchain by the miner of the virtual currency. The first transaction registered in the blockchain is configured to be unavailable without the approval of the destination included in the first destination information, i.e., both the agent and the payee.

In step S13, the payer pays the amount specified by the first amount information. In this case, the payer does not have to use a virtual currency. The payer transfers, for example, cash equivalent to the amount specified by the first amount information to the account of the agent established in a financial institution such as a bank. Alternatively, the payer may pay by cash or credit card at a store operated by the agent. Also, the payer may pay in a virtual currency different from the virtual currency used for the payment agency.

After payment by the payer has been made, the payee transmits approval information to the payment agent device 10 in step S14. The method of transmitting the approval information by the payee is not limited to a specific method. For example, the payee may transmit the approval information to the payment agent device 10 using an electronic device such as a smartphone. Alternatively, the payee may transmit the approval information to another device different from the payment agent device 10. In this case, the other device transfers the approval information to the payment agent device 10.

Upon acquiring the approval information, the payment agent device 10 executes step S15. In step S15, the second generation unit 120 generates a second transaction using the first transaction generated in step S12 and registered in the blockchain as a balance. Here, the second generation unit 120 has approval information of a plurality of destinations (i.e., the agent and the payee) included in the first transaction. Thus, the second generation unit 120 can generate a second transaction using the first transaction as a balance.

The second transaction is registered in the blockchain in a similar manner to the case of the first transaction. The user constituting the payee can use this second transaction as a balance. That is, the user constituting the payee can transmit the virtual currency of the amount indicated in the second transaction to other users, or can execute another operation.

As described above, the payment agent device 10 according to the present example embodiment has a constitution in which a first transaction indicating the agent and the payee as destinations is generated and a second transaction is generated using such first transaction as a balance. When generating these first and second transactions, an account of the payer is not required. Thus, the payer can use the virtual currency for the payment without creating an account. Therefore, the payment agent device 10 according to the present example embodiment can realize the payment agency of virtual currency in a decentralized virtual currency system with such a constitution.

Further, in the present example embodiment, the payee cannot freely use the virtual currency from the agent only by the payee's intention at the time when the first transaction is generated, and the virtual currency from the agent become available for the payee after the second transaction has been generated. By generating the above two transactions in a stepwise manner, the payment agent device 10 according to the present example embodiment can prevent an illegal use (for example, the payee's illegal use of the virtual currency before the payment by the payer to the agent has been completed), while realizing the payment agency of virtual currency.

### Second Example Embodiment

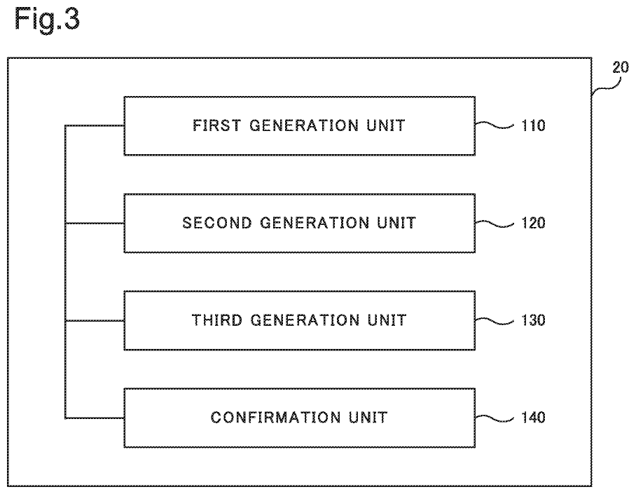

FIG. 3 is a block diagram illustrating a constitution of a payment agent device 20 according to another example embodiment. The payment agent device 20 includes a common constitution as the payment agent device 10 according to the first example embodiment. Specifically, the payment agent device 20 includes a first generation unit 110, a second generation unit 120, a third generation unit 130, and a confirmation unit 140.

Among the terms used in the following example embodiments and variants, the terms also used in the first example embodiment have the same meaning as the terms used in the first example embodiment, unless otherwise noted. Further, in the present example embodiment, the components with the same reference number as those in the first example embodiment have a similar constitution to those with the same reference number described in the first example embodiment. Thus, duplicate descriptions for such components may be omitted as appropriate.

The first generation unit 110 generates a first transaction similar to the case of the payment agent device 10 according to the first example embodiment. Similarly, the second generation unit 120 generates a second transaction similar to the case of the payment agent device 10 according to the first example embodiment.

The third generation unit 130 generates a third transaction that is different from any of the first and second transactions. The third generation unit 130 generates the third transaction using the first transaction generated by the first generation unit 110 and recorded in the blockchain as a balance. The third transaction is in common with the second transaction in that the first transaction is used as a balance.

The third generation unit 130 selectively operates with the second generation unit 120. More specifically, the second generation unit 120 operates in the case where the virtual currency is payed to the payee, whereas the third generation unit 130 operates in the case where the virtual currency is payed to the agent (i.e., returned). For example, the third generation unit 130 generates a third transaction in the case where payment by the payer has not been made, and thereby, offsets the first transaction constituting a deposit.

The third transaction includes third destination information indicating the agent as a destination, third amount information, approval information of the agent, and approval information of the payee. The third destination information is different from the second transaction in its destination. Furthermore, the amount indicated by the third amount information is equal to or less than the amount indicated by the first amount information.

The confirmation unit 140 confirms the payment by the payer. For example, the confirmation unit 140 determines whether an amount corresponding to the first amount information has been transferred to a predetermined account. Note that the payment confirmation method by the confirmation unit 140 may differ depending on the payment method by the payer. In addition, the confirmation unit 140 may set a time limit for payment of the price by the payer, i.e., a payment deadline. For example, the confirmation unit 140 may determine whether the payment by the payer is made within a predetermined period of time (one hour, one day, etc. from the request).

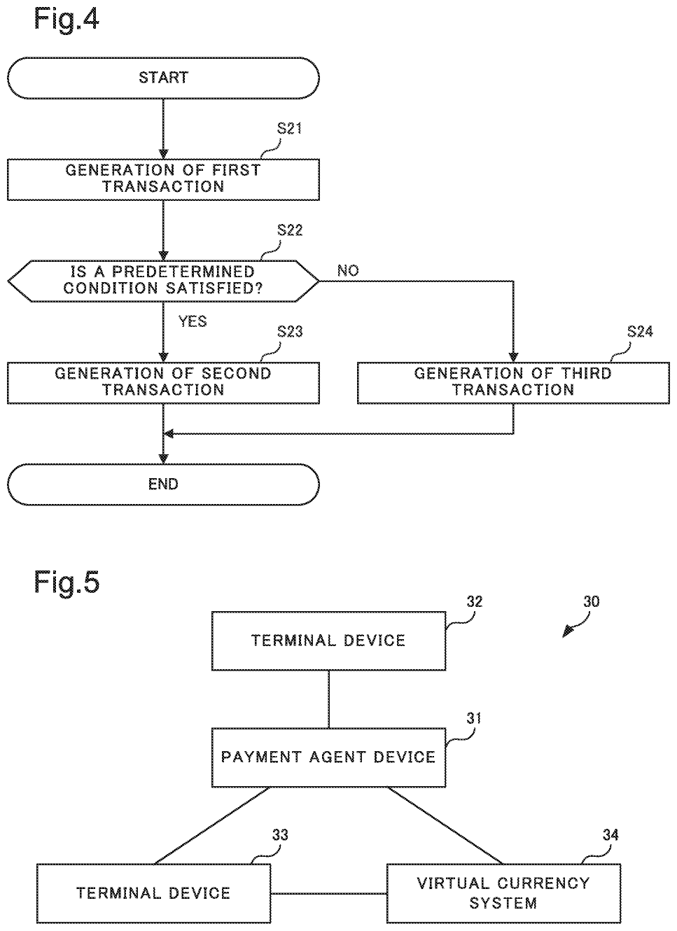

FIG. 4 is a flow chart illustrating an exemplary operation of the payment agent device 20. Note that in this exemplary operation, it is assumed that the payer and the payee can perform a similar action to the case of the first example embodiment. That is, the payer executes a similar request to the case of step S11 prior to the generation of the first transaction. Also, the payee transmits approval information to the payment agent device 20 prior to the generation of the second transaction.

In step S21, the first generation unit 110 generates a first transaction. The first generation unit 110 generates such first transaction in response to the request from the payer. Here, the information included in the first transaction is similar to the case of the first example embodiment.

In step S22, the confirmation unit 140 determines whether a predetermined condition for payment is satisfied. The condition mentioned here is, for example, “the fact that a predetermined price is payed from the payer” or “the fact that a predetermined price is payed within a predetermined period of time from the request by the payer”. In the case where the condition for payment includes a time limit, the confirmation unit 140 suspends the determination until the time limit comes.

In the case where the condition for payment is satisfied (S22: YES), the second generation unit 120 executes step S23. In contrast, in the case where the condition for payment is not satisfied (S22: NO), the third generation unit 130 executes step S24. In step S23, the second generation unit 120 generates a second transaction. In step S24, the third generation unit 130 generates a third transaction.

As described above, the payment agent device 20 according to the present example embodiment has a constitution in which either the second transaction or the third transaction is selectively generated depending on the determination result by the confirmation unit 140. This constitution makes it possible to alter the transaction destination depending on whether the payer has payed the price. Specifically, the payment agent device 20 generates a second transaction addressed to the payee in the case where the payment of the price has been made, and generates a third transaction addressed to the agent in the case where the payment of the price has not been made. Therefore, the payment agent device 20 according to the present example embodiment not only produces a similar action and a similar effect to the case of the payment agent device 10 according to the first example embodiment, but also enables the virtual currency to be returned to the agent in the case where the payment of the price has not been made appropriately.

### Third Example Embodiment

FIG. 5 is a block diagram illustrating a constitution of a payment agent system 30 according to still another example embodiment. The payment agent system 30 includes a payment agent device 31, a terminal device 32, a terminal device 33, and a virtual currency system 34.

The payment agent device 31 is computer equipment that realizes agency of trading by an agent. The payment agent device 31 corresponds to one example of the payment agent device 10 according to the first example embodiment or the payment agent device 20 according to the second example embodiment.

The terminal device 32 is a terminal device used by a user constituting the payer. In contrast, the terminal device 33 is a terminal device used by a user constituting the payee. The terminal devices 32, 33 are, for example, electronic devices such as smartphones, but their specific constitutions are not particularly limited as long as they can exchange necessary data with the payment agent device 31.

The virtual currency system 34 is a decentralized virtual currency system, and is a payment system of Peer to Peer (P2P) type virtual currency. That is, the virtual currency system 34 is constituted by a plurality of nodes of the Peer to Peer type network. It is assumed that the virtual currency in the present example embodiment is bitcoin based on NPL1. That is, the virtual currency system 34 manages the virtual currency using blockchain technology.

Note that in general, the term “bitcoin” may refer to a specific virtual currency, or may refer to a virtual currency system using such specific virtual currency. In the present example embodiment, in order to avoid confusion, the term “bitcoin” is used in the sense of virtual currency itself. Also, the currency unit of bitcoin is “BTC”.

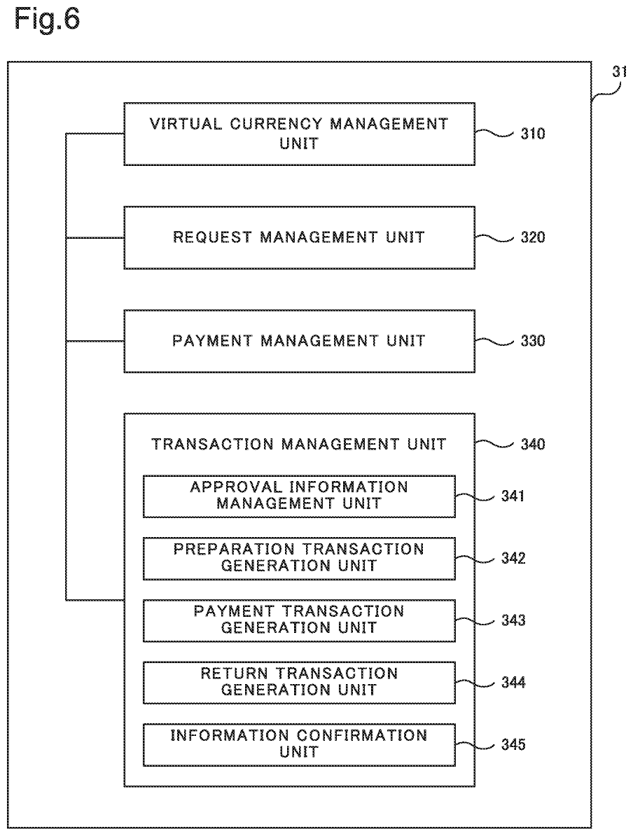

FIG. 6 is a block diagram illustrating a constitution of the payment agent device 31. The payment agent device 31 includes a virtual currency management unit 310, a request management unit 320, a payment management unit 330, and a transaction management unit 340. More specifically, the transaction management unit 340 includes an approval information management unit 341, a preparation transaction generation unit 342, a payment transaction generation unit 343, a return transaction generation unit 344, and an information confirmation unit 345.

The virtual currency management unit 310 manages the virtual currency owned by the payment agent device 31. The virtual currency management unit 310 manages the account of the agent and the balance of the virtual currency of the agent. The virtual currency management unit 310 records the account of the agent and the balance of the virtual currency of the agent on a predetermined recording medium, and reads it as necessary. In this case, the virtual currency management unit 310 may acquire the balance of the virtual currency of the agent from the virtual currency system 34 without storing such balance in the payment agent device 31.

The request management unit 320 manages a request, i.e., an asking for payment agency of the virtual currency from the payer. The request management unit 320 receives the request from the terminal device 32. The request in the present example embodiment means data including a bitcoin address for identifying the payee and payment information indicating the amount to be payed by the agent. Note that the bitcoin address is generated based on the verification key of the electronic signature of the user. The bitcoin address corresponds to one example of the “account” in the first and second example embodiments. The payment information may also include expenses such as transaction fees in addition to the amount of bitcoin to be payed to the payee. The payment information corresponds to one example of the “amount information” in the first and second example embodiments.

In addition, the request management unit 320 may compare the payment amount indicated by the payment information with the balance of the virtual currency of the agent managed by the virtual currency management unit 310. In the case where the payment amount is larger than the balance of the agent, the agent cannot perform the payment agency procedure requested by the payer. Thus, in the case where the payment amount is larger than the balance of the agent, the request management unit 320 may execute a predetermined error processing (notification to the terminal device 32, etc.).

The payment management unit 330 manages the payment of the price by the payer. For example, the payment management unit 330 receives, from the terminal device 32, a notification indicating that the payer has payed the price. Alternatively, the payment management unit 330 may receive a similar notification not from the payer but from a financial institution or from a credit card company. The payment management unit 330 notifies the payment transaction generation unit 343 that the payer has payed the price.

The payment management unit 330 may record the payment of the price by the payer as a trading history. The payment management unit 330 may further have a function of issuing a certificate for certifying that the payer has payed the price. The certificate mentioned here has an equivalent effect as a receipt. The certificate is electronic data that is typically transmitted and received electrically, but the certificate may be printed on a predetermined form and mailed to the payer.

The transaction management unit 340 manages a generation of transactions and information related to transaction generation. The approval information management unit 341 manages secret information necessary for the generation of the approval information. The secret information in the present example embodiment includes a signing key associated with the account of the agent. Further, the approval information in the present example embodiment includes an electronic signature generated using the signing key.

The transactions generated in the transaction management unit 340 can be classified into three types of transactions. Hereinafter, for convenience of explanation, these transactions are also referred to as a “preparation transaction”, a “payment transaction”, and a “return transaction”.

The preparation transaction generation unit 342 generates a preparation transaction. The preparation transaction corresponds to one example of the “first transaction” in the first and second example embodiments. That is, the preparation transaction functions as a deposit for the payment transaction described below and for the return transaction described below.

The preparation transaction includes an account of the agent, an account of the payee, payment information, and approval information of the agent. The account of the agent is managed by the virtual currency management unit 310. The account of the payee and the payment information are managed by the request management unit 320. The approval information of the agent is managed by the approval information management unit 341. Thus, the preparation transaction generation unit 342 can generate a preparation transaction using the information managed by the virtual currency management unit 310, the request management unit 320, and the approval information management unit 341.

The payment transaction generation unit 343 generates a payment transaction. The payment transaction corresponds to one example of the “second transaction” in the first and second example embodiments. The payment transaction generation unit 343 generates, based on the notification from the payment management unit 330 indicating that the payer has payed the price, a payment transaction using the preparation transaction as a balance. The balance mentioned here corresponds to an unspent transaction output (UTXO) in bitcoin.

The payment transaction includes an account of the payee, payment information, approval information of the agent, and approval information of the payee. The account of the payee, the payment information, and the approval information of the agent are included in the preparation transaction. The approval information of the payee is transmitted from the terminal device 33. Thus, the payment transaction generation unit 343 can generate a payment transaction using the preparation transaction and the approval information transmitted from the terminal device 33.

The return transaction generation unit 344 generates a return transaction. The return transaction corresponds to one example of the “third transaction” in the first and second example embodiments. The return transaction generation unit 344 generates a return transaction using the preparation transaction as a balance (i.e., UTXO).

The return transaction includes an account of the agent, payment information, approval information of the agent, and approval information of the payee. The account of the agent, the payment information, and the approval information of the agent are included in the preparation transaction. The approval information of the payee is transmitted from the terminal device 33. Thus, the return transaction generation unit 344 can generate a return transaction using the preparation transaction and the approval information transmitted from the terminal device 33.

The information confirmation unit 345 confirms the payment of the price by the payer. In the present example embodiment, the information confirmation unit 345 executes this confirmation procedure by referring to the transaction related to the agent in the virtual currency system 34. The information confirmation unit 345 particularly refers to the preparation transaction and the payment transaction. More specifically, after the preparation transaction has been recorded in the virtual currency system 34, the information confirmation unit 345 determines whether the payment transaction generated using such preparation transaction as a balance is recorded in the virtual currency system 34 by a predetermined payment deadline. The payment deadline mentioned here is set, for example, based on the timing when the payer makes a request. The payment deadline may differ depending on the price to be payed, and may be set by any of the payer, payee, and agent.

By confirming the fact that the payment transaction has been recorded in the virtual currency system 34 by the payment deadline, the information confirmation unit 345 assumes that the payment has made by the payer. The return transaction generation unit 344 generates a return transaction based on the determination result by the information confirmation unit 345. Specifically, the return transaction generation unit 344 generates a return transaction in the case where a payment transaction has not been generated by the payment deadline.

Note that the information confirmation 345 may be constituted to inquire the payment management unit 330 whether the price has been payed by the payer. That is, the information confirmation unit 345 may inquire the payment management unit 330 whether there is a notification indicating that the payer has paid the price. This constitution also makes it possible to confirm the payment of the price by the payer.

In the present example embodiment, the preparation transaction generation unit 342 corresponds to one example of the first generation unit 110 in the first and second example embodiments. Further, the payment transaction generation unit 343 corresponds to one example of the second generation unit 120 in the first and second example embodiments. The return transaction generation unit 344 corresponds to one example of the third generation unit 130 in the second example embodiment. The information confirmation unit 345 corresponds to one example of the confirmation unit 140 in the second example embodiment.

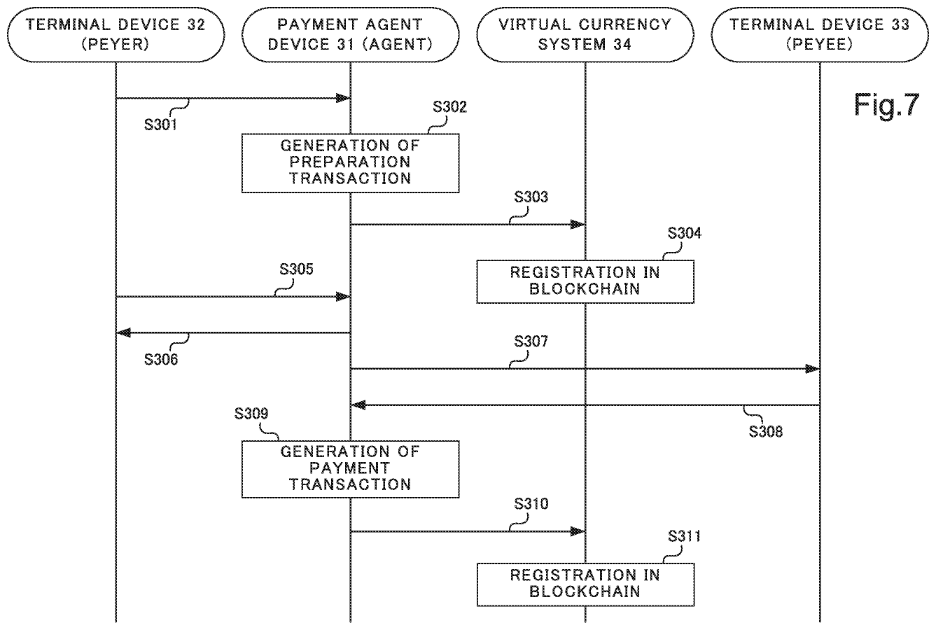

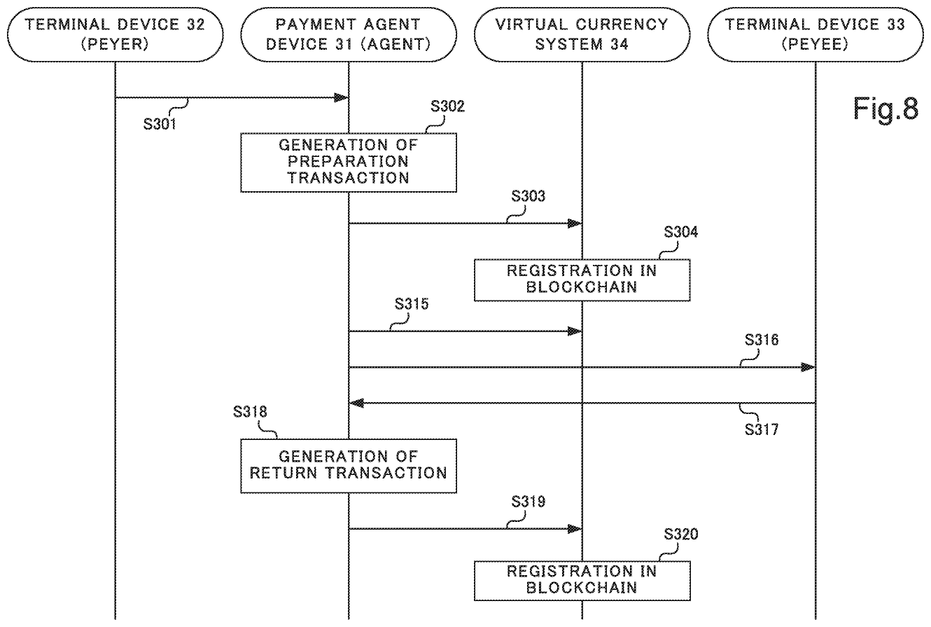

FIGS. 7 and 8 are a sequence chart illustrating an exemplary operation during trading using the payment agent device 30. FIG. 7 illustrates an exemplary operation in the case where the agent has payed the price by the payment deadline. FIG. 8 illustrates an exemplary operation in the case where the agent has not payed the price by the payment deadline. Note that in FIG. 8, the steps in which a similar processing to that in FIG. 7 is performed are denoted by the same reference numbers as in the case of FIG. 7.

In step S301, the terminal device 32 transmits a request to the payment agent device 31. This request is accompanied by payment information and a bitcoin address of the payee. The terminal device 32 executes step S301 based on the operation by the payer. The payment agent device 31 receives this request in the request management unit 320.

Upon receiving the request from the terminal device 32, the payment agent device 31 executes step S302. In step S302, the transaction management unit 340 generates a preparation transaction based on the request. In step S303, the transaction management unit 340 transmits the generated preparation transaction to the virtual currency system 34.

Upon receiving the preparation transaction from the payment agent device 31, the virtual currency system 34 executes step S304. In step S304, the virtual currency system 34 registers the preparation transaction in the blockchain. Note that the preparation transaction, the payment transaction, and the return transaction are registered in the blockchain in a similar manner to any other general transactions in bitcoin, i.e., using a well-known method.

In the example illustrated in FIG. 7, it is assumed that the payer performs a payment procedure of the price by the payment deadline. The payer may pay the price via the payment agent system 30, but the payer may also pay the price without the intervention of the payment agent system 30 (for example, by means of cash transfer). Alternatively, the payer may pay the price to the agent using a virtual currency other than bitcoin. In any case, in step S305, the terminal device 32 notifies the payment agent device 31 that the payment has been performed appropriately.

Upon receiving the notification in S305, the payment agent device 31 executes step S306. In step S306, the payment management unit 330 transmits, to the terminal device 32, a certificate indicating that the payment of the price has been completed. In addition, in step S307, the payment management unit 330 notifies the terminal device 33 that the price has been payed by a transmitter.

Note that the notification in step S307 may be executed by the terminal device 32 instead of the payment agent device 31. In such a case, the terminal device 32 executes a notification procedure to the terminal device 33, for example, upon receipt of a certificate.

Upon receiving the notification in step S307, in step S308, the terminal device 33 transmits approval information of the payee to the payment agent device 31. Upon receiving the approval information of the payee from the terminal device 33, the payment agent device 31 executes steps S309, S310.

In step S309, the transaction management unit 340 generates a payment transaction using the preparation transaction registered in the blockchain in step S304 as a balance (UTXO). In step S310, the transaction management unit 340 transmits, to the virtual currency system 34, the payment transaction thus generated in step S309.

Upon receiving the payment transaction from the payment agent device 31, the virtual currency system 34 executes step S311. In step S311, the virtual currency system 34 registers the payment transaction in the blockchain. This makes the payment transaction available to the payee.

Next, in the example illustrated in FIG. 8, steps S301 to S304 are performed similarly to the example illustrated in FIG. 7. In this example, it is assumed that the payer has not paid the price by the payment deadline. Thus, in this case, the notification in step S305 is not executed.

In this case, the payment agent device 31 executes step S315. In step S315, the transaction management unit 340 determines whether a payment transaction whose balance is the preparation transaction registered in step S304 is registered in the blockchain. In this example, since it is assumed that the price has not been paid by the payment deadline, no payment transaction is registered in the blockchain.

Note that the transaction management unit 340 may record the transaction generated by the payment agent device 31. In such a case, the transaction management unit 340 can determine the existence of the payment of the price by confirming whether generation of the payment transaction is recorded, instead of executing step S315. On the other hand, in the case where step S315 is executed, the transaction management unit 340 does not have to record the generation of the transaction.

In the case where the price has not been paid by the payment deadline, the transaction management unit 340 executes step S316. In step S316, the transaction management unit 340 notifies the terminal device 33 that the price has not been paid. In response to this notification, in step S317, the terminal device 33 transmits, to the payment agent device 31, the approval information of the payee.

Upon receiving the approval information of the payee from the terminal device 33, the payment agent device 31 executes steps S318, S319. In step S318, the transaction management unit 340 generates a return transaction using the preparation transaction registered in the blockchain in step S304 as a balance (UTXO). In step S319, the transaction management unit 340 transmits, to the virtual currency system 34, the return transaction thus generated in step S318.

Upon receiving the return transaction from the payment agent device 31, the virtual currency system 34 executes step S320. In step S320, the virtual currency system 34 registers the return transaction in the blockchain. This makes the return transaction available to the agent. That is, in the case where the price has not been paid by the payer, the amount of virtual currency paid in advance as a deposit is returned to the agent.

As described above, the payment agent system 30 according to the present example embodiment can realize, similarly to the case of the payment agent device 10 in the first example embodiment or the payment agent device 20 in the second example embodiment, the payment agency of virtual currency in a decentralized virtual currency system. In particular, the payment agent system 30 enables the payment agency in bitcoin and in the virtual currency system using bitcoin. In transactions in bitcoin, it is possible to specify a plurality of bitcoin addresses using a multi-signature (also called as a “multi-sig”).

[Variants]

The following variants can be applied to the above described first to third example embodiments, for example. These variants can be appropriately combined with each other as appropriate.

(1) In the trading of bitcoin, the terminal device 33 may transmit, to the terminal device 32, identification information for identifying trading.

In this case, the terminal device 32 incorporates, in addition to a bitcoin address and amount information, this identification information into the request. Trading information is, for example, an identifier (ID) different for each trading. In this example, the terminal device 32 transmits, to the payment agent device 31, the request including the identification information.

In the payment agent device 31, the request management unit 320 manages the identification information. For example, the request management unit 320 can determine, prior to a generation of the preparation transaction, the legitimacy of the trading based on the identification information. Specifically, the request management unit 320 inquires the terminal device 33 for the identification information, and then, determines whether the identification information transmitted from the terminal device 32 matches the identification information transmitted from the terminal device 33. In the case where the identification information acquired from the payer matches the identification information acquired from the payee, the transaction management unit 340 generates a preparation transaction. The transaction management unit 340 may incorporate the identification information into the preparation transaction.

By using such identification information, it is possible to make the correspondence (i.e., the combination) of the payee and the payer more explicit. This can facilitate the subsequent generation, registration, and confirmation procedures for a payment transaction or for a return transaction.

(2) The request management unit 320 may create an account of the payer. In the virtual currency system using bitcoin, necessary information for creating an account (i.e., bitcoin address) is a verification key of the electronic signature. Thus, in this example, the request management unit 320 receives a request including the verification key from the terminal device 32. The request management unit 320 generates a bitcoin address of the payer using the verification key transmitted from the terminal device 32.

In this case, the transaction management unit 340 incorporates the payer as a destination into the preparation transaction. That is, the preparation transaction in the present example includes the payer as a destination, in addition to the agent and the payee. Furthermore, the transaction management unit 340 incorporates approval information of the payer into the payment transaction. The approval information of the payer is, for example, transmitted from the terminal device 32 to the payment agent device 31 triggered by the reception of the certificate (step S306).

In this case, the payment transaction may not necessarily include the approval information of the payee. That is, in this example, the approval information included in the payment transaction is the approval information of the agent and the approval information of the payee or the payer. For example, the transaction management unit 340 may generate a payment transaction including approval information of the agent, the payer, and the payee, or alternatively, may generate a payment transaction including approval information of the agent and the payer. Thus, in this case, the processes of steps S307, S308 in FIG. 7 are not essential.

In this way, due to the fact that the payment agent device 31 performs the creation of the payer's account on behalf of the payer, it is possible to eliminate the need for the approval information of the payee at the time of generation of the payment transaction. As a result, the terminal device 33 does not have to transmit the approval information of the payee.

(3) The specific hardware configuration of the devices (the payment agent devices 10, 20, and 31) according to the present disclosure includes various variations, and is not limited to a specific configuration. For example, the device according to the present disclosure may be implemented using software, or alternatively, may be configured to share various types of processing using a plurality of hardware.

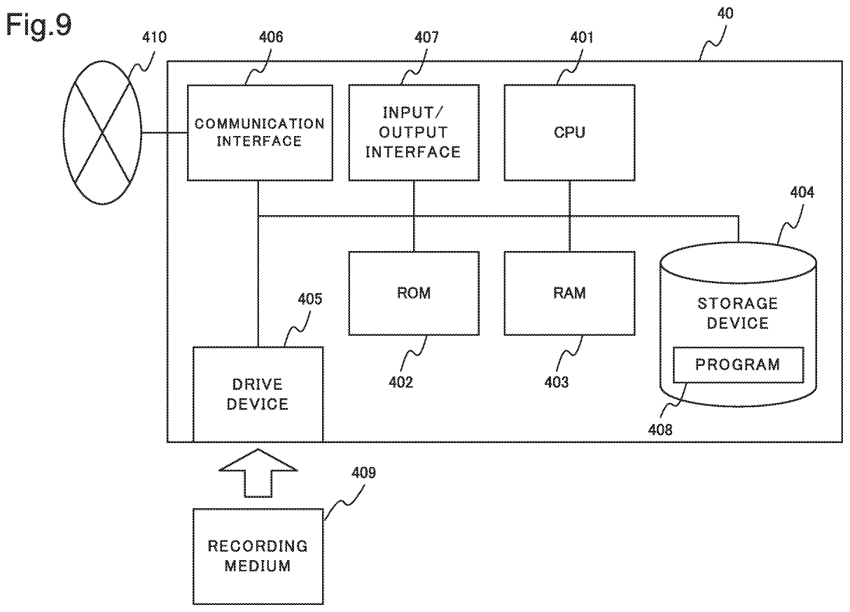

FIG. 9 is a block diagram illustrating one example of a hardware configuration of computer equipment 40 that implements the device according to the present disclosure. The computer equipment 40 is configured to include a central processing unit (CPU) 401, a read only memory (ROM) 402, a random access memory (RAM) 403, a storage device 404, a drive device 405, a communication interface 406, and an input/output interface 407.

The CPU 401 executes a program 408 using the RAM 403. The communication interface 406 exchanges data with an external device via the network 410. The input/output interface 407 exchanges data with peripheral devices (such as input devices and display devices). The communication interface 406 and the input/output interface 407 can function as components for acquiring or outputting data.

Note that the program 408 may be stored within the ROM 402. Alternatively, the program 408 may be recorded on a recording medium 409 such as a memory card and may be read by the drive device 405, or alternatively, may be transmitted from an external device via the network 410.

The device according to the present disclosure can be realized by the configuration (or a portion thereof) illustrated in FIG. 9. For example, in the case of the payment agent device 10 or 20, the first generation unit 110, the second generation unit 120, the third generation unit 130, and the confirmation unit 140 correspond to the CPU 401, the ROM 402, and the

Note that the components of the device according to the present disclosure may be configured by a single circuitry (processor etc.), or alternatively, may be configured by a combination of a plurality of circuitry. The circuitry mentioned here may be either a dedicated circuitry or a general circuitry. For example, with regard to the device according to the present disclosure, a portion thereof may be implemented by one or more dedicated processors and the remainder thereof may be implemented by one or more general processors.

The constitution described as a single device in the above-described example embodiments may be distributed to a plurality of devices. For example, the payment agent device 10, 20, or 31 may be realized by collaboration of a plurality of computer equipment using a cloud computing technology or the like.

The present invention has been described above by taking the above described example embodiments and variants as typical examples. However, the present invention is not limited to these example embodiments and variants. The present invention may include any example embodiments to which various variations or applications that can be grasped by so-called those skilled in the art can be applied within the scope the present invention. In addition, the present invention may include any example embodiments in which the matters described herein are combined or replaced as appropriate. For example, matters described using a particular example embodiment may be applied to other example embodiments as long as no contradiction arises.

### REFERENCE SIGNS LIST

10, 20 Payment agent device
110 First generation unit
120 Second generation unit
130 Third generation unit
140 Confirmation unit
30 Payment agent system
31 Payment agent device
32, 33 Terminal device
34 Virtual currency system

40 Computer equipment

What is claimed is:

1. A payment agent device for a virtual currency, comprising:
at least one memory storing instructions; and
at least one processor configured to access the at least one memory and execute the instructions to:
generate, in response to a request from a payer, a first transaction that includes first destination information indicating at least an agent and a payee as destinations, first amount information, and approval information of the agent; and
generate, based on approval information of the payee transmitted therefrom and using the first transaction as a balance, a second transaction that includes second destination information indicating the payee as a destination, second amount information, the approval information of the agent, and the approval information of the payee.

2. The payment agent device according to claim 1, wherein at least one processor is further configured to execute the instructions to:
generate, based on the approval information of the payee transmitted therefrom and using the first transaction as a balance, a third transaction that includes third destination information indicating the agent as a destination, third amount information, the approval information of the agent, and the approval information of the payee.

3. The payment agent device according to claim 2, wherein at least one processor is further configured to execute the instructions to:
confirm payment of price by the payer,
generate the second transaction when the payment of the, price is confirmed, and
generate the third transaction when the payment of the price has not been confirmed.

4. The payment agent device according to claim 1, wherein at least one processor is further configured to execute the instructions to:
create, in response to a request from the payer, an account of the payer,
generate the first transaction that indicates the payer as a destination, and
generate the second transaction that includes the approval information of the agent and either of the approval information of the payee or approval information of the payer.

5. The payment agent device according to claim 1, wherein at least one processor is further configured to execute the instructions to:
acquire identification information for identifying trading of the virtual currency from the payer and from the payee, and generate the first transaction in the case where the identification information acquired from the payer matches the identification information acquired from the payee.

6. The payment agent device according to claim 1, wherein the virtual currency is bitcoin, and
wherein at least one processor is further configured to execute the instructions to generate the second transaction using the first transaction as an unspent transaction output (UTXO).

7. A payment agent method for a virtual currency, the method comprising:
generating, in response to a request from a payer, a first transaction that includes first destination information indicating at least an agent and a payee as destinations, first amount information, and approval information of the agent; and
generating, based on approval information of the payee transmitted therefrom and using the first transaction as a balance, a second transaction that includes second destination information indicating the payee as a destination, second amount information, the approval information of the agent, and the approval information of the payee.

8. A non-transitory computer-readable program recording medium for causing a computer to execute:
generating, in response to a request from a payer, a first transaction that includes first destination information indicating at least an agent and a payee as destinations, first amount information, and approval information of the agent; and
generating, based on approval information of the payee transmitted therefrom and using the first transaction as a balance, a second transaction that includes second destination information indicating the payee as a destination, second amount information, the approval information of the agent, and the approval information of the payee.

9. The payment agent device according to claim 2, wherein at least one processor is further configured to execute the instructions to:
create, in response to a request from the payer, an account of the payer,
generate the first transaction that indicates the payer as a destination, and
generate the second transaction that includes the approval information of the agent and either of the approval information of the payee or approval information of the payer.

10. The payment agent device according to claim 3, wherein at least one processor is further configured to execute the instructions to:
create, in response to a request from the payer, an account of the payer,
generate the first transaction that indicates the payer as a destination, and
generate the second transaction that includes the approval information of the agent and either of the approval information of the payee or approval information of the payer.

11. The payment agent device according to claim 2, wherein at least one processor is further configured to execute the instructions to:
acquire identification information for identifying trading of the virtual currency from the payer and from the payee, and generate the first transaction in the case where the identification information acquired from the payer matches the identification information acquired from the payee.

12. The payment agent device according to claim 3, wherein at least one processor is further configured to execute the instructions to:
acquire identification information for identifying trading of the virtual currency from the payer and from the payee, and generate the first transaction in the case where the identification information acquired from the payer matches the identification information acquired from the payee.

13. The payment agent device according to claim 4, wherein at least one processor is further configured to execute the instructions to:
acquire identification information for identifying trading of the virtual currency from the payer and from the payee, and generate the first transaction in the case where the identification information acquired from the payer matches the identification information acquired from the payee.

14. The payment agent method for a virtual currency according to claim 7, further comprising:
generating, based on the approval information of the payee transmitted therefrom and using the first transaction as a balance, a third transaction that includes third destination information indicating the agent as a destination, third amount information, the approval information of the agent, and the approval information of the payee.

15. The payment agent method for a virtual currency according to claim 8, further comprising:
confirming payment of price by the payer,
generating the second transaction when the payment of the price is confirmed, and
generating the third transaction when the payment of the price has not been confirmed.

16. The payment agent method for a virtual currency according to claim 7, further comprising:
creating, in response to a request from the payer, an account of the payer,
generating the first transaction that indicates the payer as a destination, and
generating the second transaction that includes the approval information of the agent and either of the approval information of the payee or approval information of the payer.

17. The payment agent method for a virtual currency according to claim 7, further comprising:
acquiring identification information for identifying trading of the virtual currency from the payer and from the payee, and
generating the first transaction in the case where the identification information acquired from the payer matches the identification information acquired from the payee.

18. The payment agent method for a virtual currency according to claim 7, further comprising:
generating the second transaction using the first transaction as an unspent transaction output, wherein the virtual currency is bitcoin.
